(19) United States
(12) Patent Application Publication
(10) Pub. No.: US 2011/0183302 A1
(43) Pub. Date: Jul. 28, 2011

(54) Situational Awareness Training System and Method

(76) Inventor: Robert W. Harlow, Houston, TX (US)

(21) Appl. No.: 12/695,345

(22) Filed: Jan. 28, 2010

(51) Int. Cl. G09B 19/18; G09B 19/00; G09B 7/00

(52) U.S. Cl. 434/107; 434/219; 434/247; 434/323; 434/335

(57) ABSTRACT

The invention provides a system and method of providing interactive situational awareness training. In one embodiment, the present invention displays training data comprising situational, variable, and response data relating to a particular training session upon a graphic user interface for review by a trainee. In one embodiment, the training data may be accessed and amended electronically by trainer personnel. Images, graphics and/or animations may be presented to the user in conjunction with the training data to enhance the effectiveness of the interactive training experience. The trainee may be prompted to enter a response indicating his or her choice of the proper response to the displayed training data. The entered response may be stored for future use and compared to feedback data indicating which of the displayed response choices are correct.

### FIELD OF THE INVENTION

The present invention relates generally to training systems and, more particularly, to systems and methods of providing interactive situational awareness training.

### BACKGROUND OF THE INVENTION

Athletic trainers and coaches are tasked with providing each and every athlete with sufficient training to prepare them for athletic events. Such training involves not only situational awareness, i.e., desired action(s) by the athlete in response to stimuli occurring during an athletic event, but also physical training designed to enhance the athlete's strength, endurance, and skills relating to the sport in question. This can be a monumental task considering the complexity of some sporting events and the number of athletes on a sports team. In many cases, there is simply not enough time for trainers and coaches to adequately prepare each athlete for an upcoming sporting event.

In the past, trainers and coaches have relied upon generic materials, such as playbooks and videotapes, to assist in preparing each athlete for an upcoming sporting event. Unfortunately, such materials may be costly to generate and costly to amend since changes to the original may require a reprint and/or reproduction. Further, such materials are often ineffective teaching tools because they are tedious to use and are not interactive.

As such, there remains a need for a situational awareness training system and method capable of providing for the effective and dynamic interactive instruction and reinforcement of training principles.

### SUMMARY OF THE INVENTION

Accordingly, the present invention provides a system and method for providing interactive situational awareness training in a variety of contexts. The present invention provides one or more training modules containing interactive training content directed to a particular training subject, such as sports training, military training, cultural/business training, law enforcement training, etc. In one embodiment, the training data may be accessed and amended electronically by trainer personnel at any time. This feature of the present invention allows each training session to be dynamically tailored for each upcoming opponent and/or event as well as kept up to date with the latest information.

In one embodiment, each training module of the invention provides one or more sub-modules having interactive content directed to a sub-group of the subject addressed by the training module. For example, a sports training module may provide sub-modules containing interactive training content directed to individual sports such as baseball, football, soccer, basketball, etc.

In one embodiment, the present invention provides an interactive training experience by displaying training data comprising situational, variable, and response data relating to a particular training session upon a graphic user interface for review by a trainee. In one embodiment, images, graphics, sound effects and/or animations may be presented to the trainee in conjunction with the training data to enhance the effectiveness of the interactive training experience.

After reviewing the training data and any accompanying graphics and/or sounds effects, the trainee may be presented with a plurality of response options. The trainee may be prompted to enter his or her choice of the correct option in light of the training data provided by the system. Statistical data relating to trainee responses may be stored for future use. This feature of the present invention allows trainer personnel to analyze trainee performance during training sessions. Feedback data may also be displayed to the trainee in order to reinforce the correct course of action. The present invention may be loaded onto any number of portable electronic devices in order to provide trainers and trainees with mobile access to the system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings; it being understood that the drawings contained herein are not necessarily drawn to scale; wherein:

FIG. 1 is a flowchart diagram illustrating the training session initiation process of one embodiment of the present invention.

FIG. 2 is a flowchart diagram illustrating an example training session of one embodiment of the present invention.

FIGS. 3-4 are example graphic user interfaces that may be used in conjunction with one embodiment of the present invention.

FIG. 5 is a component diagram illustrating an example computer system that may be utilized in one embodiment of the present invention.

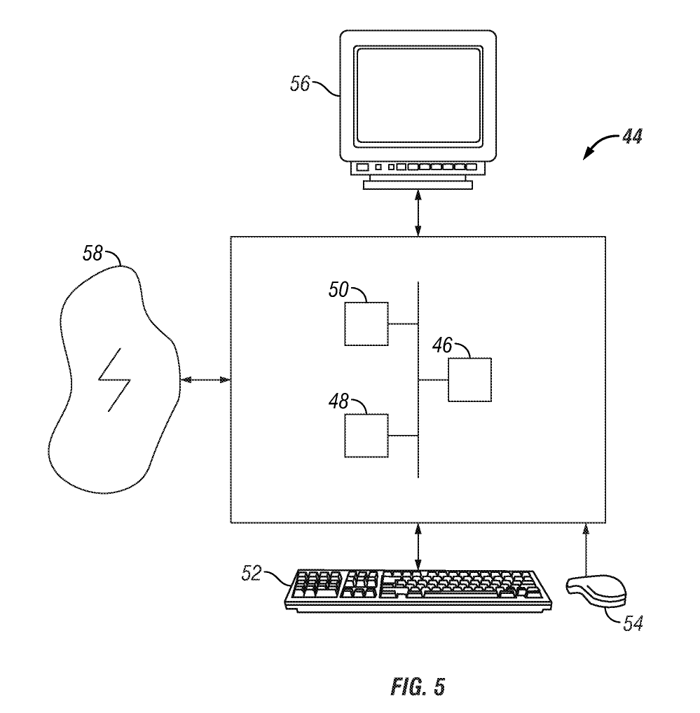

### DETAILED DESCRIPTION OF THE INVENTION

In the following description, numerous details are set forth to provide an understanding of the present invention. However, it will be understood by those skilled in the art that the present invention may be practiced without these details and that numerous variations or modifications from the described embodiments may be possible.

The present invention is herein described as a method of providing interactive situational awareness training, as a computer-readable storage medium for providing interactive situational awareness training, and as an interactive situational awareness training system.

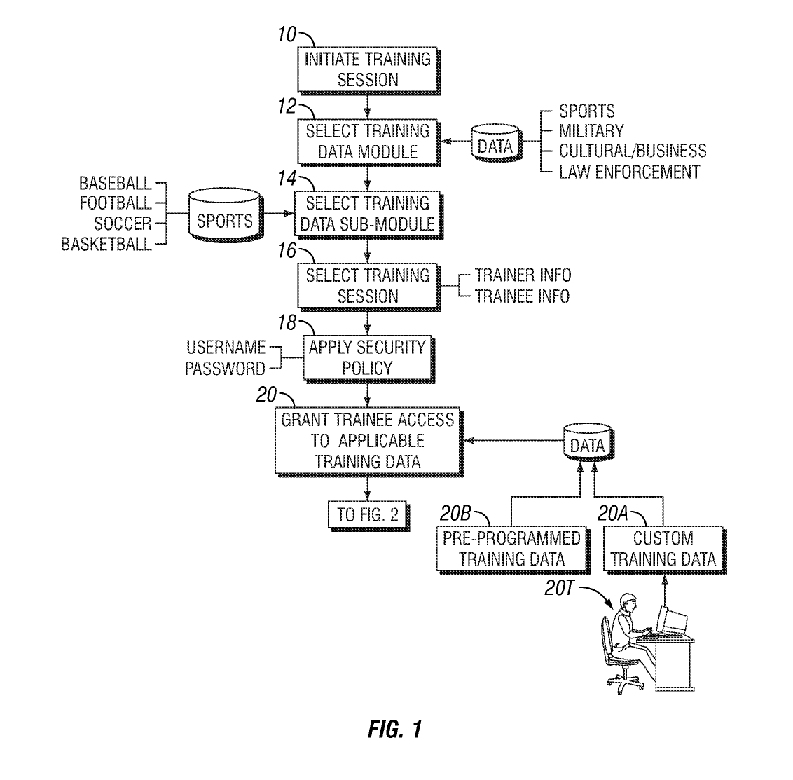

The present invention provides a unique and versatile interactive situational awareness training program. Referring to FIG. 1, the initiation of a situational training session according to one embodiment of the present invention is illustrated by Box (10). A training module may then be selected by the trainer or the trainee as illustrated by Box (12). In one embodiment, the invention provides a plurality of training modules, each containing training data relating to a particular training subject, such as sports training, military training, cultural/business training, law enforcement training, etc. Although many of the examples described herein address the use of separate modules containing training data, it should be understood that such data may be stored in any suitable format according to any suitable storage convention and is not limited to the use of separate modules.

A sub-training module may be selected by the trainer or the trainee, as illustrated by Box (14), in order to provide training in one or more distinct subjects. In one embodiment, each training module of the present invention may provide one or more sub-modules having interactive training content directed to a sub-group of the subject matter addressed by the training module. For example, a sports training module may provide sub-modules containing interactive training content directed to individual sports such as baseball, football, soccer, basketball, etc.

In one embodiment, training data stored by the system may include, but is not limited to, situational data, variable data, response data, and feedback data. In one embodiment, the training data may be accessed and amended electronically by trainer personnel at any time. This feature of the present invention allows each training session to be dynamically tailored for each upcoming opponent and/or event.

In one embodiment, access to the training program(s) of the present invention may be facilitated by entering trainer and trainee data, as illustrated by Box (16). This feature allows access to certain training programs to be restricted to certain trainees. For example, training programs designed for third basemen can be restricted to those trainees who currently play this position or those who may play the position in case of an injury or other circumstances requiring a position change. This feature of the present invention facilitates effective situational awareness training by focusing trainees on the most relevant subject matter.

A username and password may be required in order to provide security to sensitive training data and restrict access to authorized individuals, as illustrated by Box (18). Once access to a given training session is granted to a trainee, the system provides access to data relating thereto, as illustrated by Box (20).

In one embodiment, the invention allows training personnel (20T) to enter training data into the system through any suitable input device at any time. This feature of the present invention allows training personnel to dynamically tailor each training program as they see fit and update such training programs at their discretion, as illustrated by Box (20A). For example, if training personnel receive new intelligence regarding an upcoming opponent, they can immediately update the training data utilized by the system. This can be accomplished using any suitable hardware configuration, including the use of mobile devices having access to a network. A customized graphic user interface (not shown) may also be provided for use by training personnel to enter custom training data into the system. The present invention may also provide pre-programmed training data useful for any number of situational training sessions, as illustrated by Box (20B).

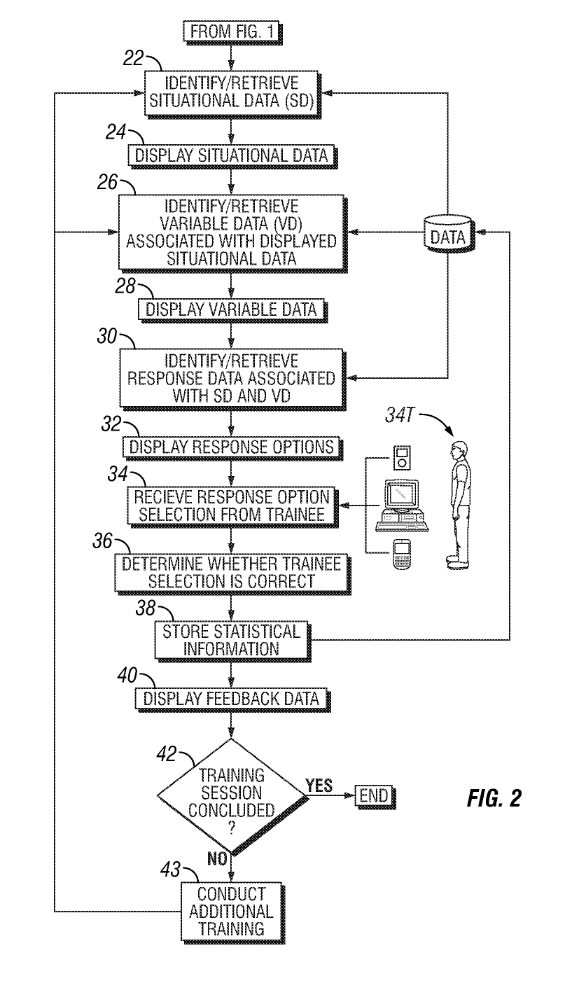

Referring to FIGS. 2-4, in one embodiment, training data utilized by the present invention may include situational data (23) for defining a fixed set of factual circumstances to be applied to a particular training session. For example, situational data relating to a sports training session for baseball may require that the trainee assume he or she is playing the third base position during the training session. In one embodiment, situational data remains the same for the duration of a particular training session, i.e., in this example, the trainee is asked to assume he or she is playing the third base position during the training session in question. Once a training session is initiated, situational data relating thereto may be identified, retrieved, and displayed to the trainee, as illustrated by Boxes (22) and (24), upon a suitable graphic user interface (21).

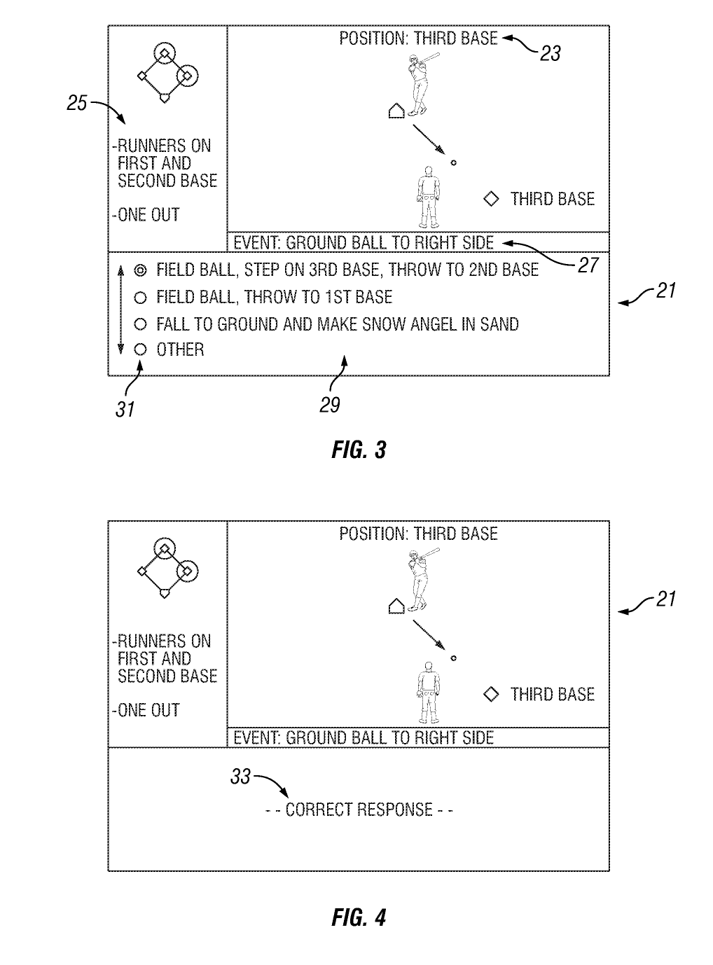

In one embodiment, training data utilized by the present invention may include variable data (25) for defining random training circumstances to be applied to situational awareness training sessions in conjunction with situational data (23). In the baseball sports training example above, variable data may include an indication that there is “1 out” and that there are “base runners on first and second base,” as illustrated by FIGS. 3 and 4.

Variable data may also include data indicating the occurrence of a particular event occurring in the context of the situational and variable data. In the baseball sports training example, variable event data (27) may indicate that the batter hits a ground ball to the right side of the trainee who, according to the situational data, is assumed to be playing the third base position. Variable data relating to the situational data may be identified, retrieved, and displayed to the trainee concurrently with the display of situational data or shortly thereafter, as illustrated by Boxes (26) and (28) of FIG. 2.

In one embodiment, training data utilized by the present invention may include response data (29) for defining possible courses of action to be taken by the trainee in light of the situational and variable data, as illustrated by FIGS. 3 and 4. In the baseball sports training example, response data may include courses of action to be taken by the trainee in light of the circumstances presented by the situational and variable data. For example, a response to the situational and variable data in the baseball training example above could include “field ground ball, step on third base for force out, throw to second base for double play,” amongst other response options. Response data relating to the situational and variable data may be identified, retrieved, and displayed to the trainee concurrently with the display of such data or shortly thereafter, as illustrated by Boxes (30) and (32) of FIG. 2. Response options may include response fields (31) or other input functionalities through which the user may select the desired response.

In one embodiment, multiple response options are provided by the system and the trainee is prompted to enter a response selection in order to effectively test and develop the trainee's preferred response to the conditions set forth in the training session. The present invention may provide an “other” option as one of the response choices to discourage reliance upon probability by the trainee during a training session. Further, in one embodiment, if the “other” response option is chosen by the user, the system may provide one or more additional sets of response options to ensure thorough analysis by the trainee.

Moreover, the trainer may enter time limits during which a trainee must complete an entire training session and/or select a response option in response to a particular set of variables displayed by the system. Time limits set by the trainer can be displayed concurrently with the training data during a training session. In one embodiment, the system will display a “time limit exceeded” message if the trainee fails to enter a response within the allocated time. Further, the system may automatically proceed to the next set of training variables if the time limit is exceeded.

Upon receipt of a response option selection by the trainee (34T), the present invention compares the response with stored training data in order to determine whether the correct option was chosen, as illustrated by Boxes (34) and (36) of FIG. 2. Further, at each stage of the training session, statistical information may be stored for later use by the trainer or the trainee, as illustrated by Box (38). For example, statistical information relating to the trainee's performance during one or more training sessions may be analyzed by the trainer in order to determine the trainee's readiness for a particular position or upcoming event. Statistical data may also be used to determine strong versus weak areas in the trainee's situational awareness to enable the trainer to amend the training data to focus on weaker areas during later training sessions.

In one embodiment, training data utilized by the present invention may include feedback data for defining which response option is preferred in light of the conditions of the training session, as well as the reason(s) why the response option is correct. Feedback data (33) may be displayed to the user in any suitable manner in order to reinforce the best course of action to the trainee, as illustrated by Box (40). In one embodiment, the present invention provides an “instant” feedback setting which can be selected by the trainer to enable feedback data to be displayed immediately after the trainee enters a response option. The above training process may be continued until each combination of situational awareness training data (as desired by the trainer) has been presented to and responded to by the trainee, as illustrated by Box (42) and (43) of FIG. 2.

In one embodiment, training data may include text and/or audio/visual materials such as images, graphics, sound effects or animations in order to enhance the effectiveness of the interactive training experience, as illustrated by FIGS. 3 and 4. In the baseball example above, images relating to the situational data, i.e., playing the third base position, could include text and/or graphical representation(s) of the trainee's position adjacent to third base; base runners at first and second base could be highlighted and/or pulsate; a graphic of the ball moving from the batter to the right side of the trainee as well as the sound of the ball being struck by the batter could be used to enhance the training session, etc. It being understood that these are merely examples and that various text, graphics, images, sound effects, and/or animations could be utilized as training data by the system. In one embodiment, the system provides software designed to allow the trainer to manually enter custom text, images, graphics, sound effects and/or animations to be used as training data.

Upon completion of a training session, statistical data may be displayed to the trainee to reinforce situational awareness principles. Statistical data may also include the time it takes the trainee to complete one or more situational awareness training sessions. Additional training sessions may also be implemented depending on the training regimen developed by the trainer. In one embodiment, the present invention allows the trainer to store training regimens for individual trainees comprising multiple training sessions. Such training sessions may be drawn to any modules or sub-modules offered by the system and saved by the system so that the complete training regimen is retrieved and executed upon entry of the trainee's username and password.

In one embodiment, the present invention provides programming to allow training personnel to set electronic alerts informing the trainer when the trainee has completed any given training session. This may be accomplished via any suitable method of communication, such as text message, electronic email, etc.

It should be understood that the invention may be applied to any number of training subjects and is not limited to the example embodiments disclosed herein. In short, the present invention may be applied to any field where the repetitive training of protocols and/or rules of engagement would be beneficial. In one embodiment, this may be accomplished by selecting pre-existing training data relating to the desired subject matter and/or through the entry of custom training data relating thereto. For example, the baseball training example above could easily be applied to law enforcement training upon selection of training data relating to law enforcement or entry of custom training data relating thereto. To illustrate, a law enforcement training session could utilize situational training data requiring that the trainee assume he or she is responding to a domestic disturbance at a residence. Variable training data in this example could include an indication that “there is a backup unit on the way” and that “gunshots have been reported.” Variable event data could include that “screams can be heard from inside the residence upon arrival.” Response data could include courses of action to be taken by the trainee in light of the circumstances presented by the situational and variable data such as “draw weapon, rush into front door of residence,” amongst other response options.

The present invention may be implemented on virtually any type of computer device regardless of the platform being used. Referring to FIG. 1, a computer device (44) includes a processor (46), associated memory (48), a storage device (50), and numerous other elements and functionalities typical of modern computing devices (not shown). The computer (44) may also include input devices, such as a keyboard (52), mouse (54), touch screen (not shown), and output devices, such as a display monitor (56).

The computer (44) may be connected to a local area network (LAN) or a wide area network (e.g., the Internet) (58) via a wired or wireless connection (not shown). Those skilled in the art will appreciate that these input and output devices may take other forms, now known or later developed. Further, those skilled in the art will appreciate that one or more elements of the aforementioned computer system (44) may be located at a remote location and connected to the other elements over a network.

The invention may be implemented on a distributed system having a plurality of individual computer devices, where portions of the invention may be located on a different system within the distributed system. For example, trainer computing devices may be enabled to allow for entry and amendment of training data while trainee devices are limited to executing individual training sessions.

The present invention may also be implemented upon any number of hand-held or other portable computing devices. Further, software instructions to perform embodiments of the invention may be stored on a computer readable medium such as a compact disc (CD), DVD, diskette, tape, file, hard drive, flash drive, SD memory card, or any other suitable computer readable storage device.

Although the invention has been described with reference to specific embodiments, this description is not meant to be construed in a limited sense. Various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention.

What is claimed is:

1. A method of providing interactive situational awareness training comprising the steps of:
providing a microprocessor, a display device coupled to the microprocessor, a storage device coupled to the microprocessor, and an input device coupled to the microprocessor;
wherein the storage device provides training data comprising:
situational data defining fixed factual circumstances to be applied to situational awareness training sessions;
variable data defining random training circumstances to be applied to situational awareness training sessions in conjunction with situational data; and
response data defining possible courses of action to be chosen by a user in response to situational data and variable data;
identifying a subset of situational data pertaining to a particular situational awareness training session;
displaying the subset of situational data;
identifying a subset of variable data associated with the displayed subset of situational data;
displaying the subset of variable data;
identifying response data associated with the displayed subset of situational data and the displayed subset of variable data;
displaying response options associated with the identified response data; and
receiving a response selection entered by the user.

2. The method of claim 1, wherein said training data further comprises a plurality of images, sound effects, graphics or animations and further comprises the additional step of:
presenting the images, sound effects, graphics, or animations relating to the training data.

3. The method of claim 1, further comprising the additional step of:
storing statistical information relating to the user's response selection.

4. The method of claim 1, wherein said training data may be amended by trainer personnel.

5. The method of claim 1, wherein said training data is selected from the group consisting of sports, cultural awareness, law enforcement, and military.

6. The method of claim 1, further comprising the additional step of:
determining whether the response selection entered by the user is correct.

7. The method of claim 6, further comprising the additional step of:
displaying the correct response option to the user.

8. A computer-readable storage medium for providing interactive situational awareness training comprising instructions which, when executed, cause a computing device to:
access stored training data comprising:
situational data defining fixed factual circumstances to be applied to situational awareness training sessions;
variable data defining random training circumstances to be applied to situational awareness training sessions in conjunction with situational data; and
response data defining possible courses of action to be chosen by a user in response to situational data and variable data;
identify a subset of situational data pertaining to a particular situational awareness training session;
display the subset of situational data;
identify a subset of variable data associated with the displayed subset of situational data;
display the subset of variable data;
identify response data associated with the displayed subset of situational data and the displayed subset of variable data;
display response options associated with the identified response data; and
receive a response selection entered by the user.

9. The computer readable storage medium of claim 8, wherein said training data further comprises a plurality of images, sound effects, graphics or animations and wherein the instructions, when executed, cause the computing device to:
present images, sound effects, graphics, or animations relating to the training data.

10. The computer readable storage medium of claim 8, wherein the instructions, when executed, cause the computing device to:
store statistical information relating to the user's response selection.

11. The computer readable storage medium of claim 8, wherein the training data may be amended by trainer personnel.

12. The computer readable storage medium of claim 8, wherein the instructions, when executed, cause the computing device to:
determine whether the response selection entered by the user is correct.

13. The computer readable storage medium of claim 12, wherein the instructions, when executed, cause the computing device to:
display the correct response option to the user.

14. An interactive situational training system comprising:
a microprocessor;
a display device coupled to the microprocessor;
an input device coupled to the microprocessor; and
a storage device coupled to the microprocessor, the storage device providing training data comprising:
situational data defining fixed factual circumstances to be applied to situational awareness training sessions;
variable data defining random training circumstances to be applied to situational awareness training sessions in conjunction with situational data; and
response data defining possible courses of action to be chosen by a user in response to situational data and variable data;
wherein said microprocessor is configured to:
identify a subset of situational data pertaining to a particular situational awareness training session;
display the subset of situational data;
identify a subset of variable data associated with the displayed subset of situational data;
display the subset of variable data;
identify response data associated with the displayed subset of situational data and the displayed subset of variable data;
display response options associated with the identified response data; and
receive a response selection entered by the user.

15. The interactive situational training system of claim 14, wherein said training data further comprises a plurality of images, sound effects, graphics or animations and wherein the microprocessor is configured to:
present the images, sound effects, graphics, or animations relating to the training data.

16. The interactive situational training system of claim 14, wherein the microprocessor is configured to:
store statistical information relating to the user's response selection.

17. The interactive situational training system of claim 14, wherein the training data may be amended by trainer personnel.

18. The interactive situational training system of claim 14, wherein the microprocessor is configured to:
determine whether the response selection entered by the user is correct.

19. The interactive situational training system of claim 18, wherein the microprocessor is configured to:
present the correct response option to the user.
